(19) United States
(12) Patent Application Publication
(10) Pub. No.: US 2004/0145340 A1
(43) Pub. Date: Jul. 29, 2004

(54) Motorcycle jumper cable and battery charger

(76) Inventor: Randy Jay Horenstein, Miami, FL (US)

Correspondence Address: LITMAN LAW OFFICES, LTD., P.O. BOX 15035 CRYSTAL CITY STATION, ARLINGTON, VA, 22215, US

(21) Appl. No.: 10/345,983

(22) Filed: Jan. 17, 2003

(51) Int. Cl. H02J 7/00; H02J 7/14

(52) U.S. Cl. 320/105

(57) ABSTRACT

A motorcycle jumper cable includes a permanently installed section on a motorcycle and a detachable section for connecting an undercharged motorcycle battery with an auxiliary battery to “jump-start” or “boost” the undercharged battery. The two sections are connected together using hermaphroditic connectors that ensure proper polarity during use. An additional extension can be provided that includes the hermaphroditic connectors on each end. Also, a battery charger having a hermaphroditic connector is optionally provided.

### BACKGROUND OF THE INVENTION

1. Field of the Invention

The present invention relates to modular motorcycle jumper cables (also called “booster cables”) having one section fixed to the motorcycle's battery and one or more sections coupled to the fixed section by a “quick connect” coupling, and which may be connected to a second vehicle battery for a jump start. A battery charger is provided with a “quick connect” coupling which may be connected to the modular motorcycle jumper cables for charging the battery in the charging mode, or for starting the motorcycle in a starting or boosting mode.

2. Description of the Related Art

Vehicle “jumper” cables are well known for “jump starting” or “boosting” undercharged vehicle batteries, such as cars, motorcycles, boats, etc. “Jump-starting” involves transferring electrical energy from a charged battery to an undercharged or discharged battery so that the electrical starter can be operated to turn over an engine. The jump start may be supplied from (1) a second vehicle with a fully charged battery; (2) an A.C. battery charger which may be switchable between a trickle charge mode and a high amperage starting mode; and (3) a battery booster having a rechargeable battery which may be used for jump starting a vehicle or as a D.C. power supply for twelve volt accessories. Once the engine on the vehicle having the undercharged or discharged battery is started, the vehicle can then begin generating its own power using its generator or alternator and the cables are then removed.

Motorcycles, as opposed to most other vehicles, are equipped with batteries that are generally inaccessible to jumper cables. That is, substantial effort must be expended to remove obstructing structures (such as the seat) to reach the battery terminals in order to connect jumper cables to. the battery terminals. Therefore, jump-starting a motorcycle is a labor-intensive activity. The present invention reduces or removes the labor-intensive aspect of jump-starting a motorcycle by providing a readily connectable modular jump starting cable, one part of which is permanently installed on the motorcycle and having at least one other part that connects the motorcycle to the power-supplying vehicle, e.g., to a battery of a passenger vehicle or to another motorcycle similarly equipped with a permanently installed cable part.

Furthermore, the inventive cable may be provided with hermaphroditic connectors that ensure proper polarity when connected

Various patents have described jumper cables and battery boosters for motor vehicles. U.S. Pat. No. 4,042,759, issued to Cella on Aug. 16, 1977, teaches a battery having terminals that are modified to be able to quickly connect and disconnect the terminal cables. U.S. Pat. No. 4,272,142, issued to Zapf on Jun. 9, 1981, teaches a two-part jumper cable including a separable connector that can be coupled only when the correct polarity is present between the two parts. The ends of the cable are each provided with a pair of clamps for connecting to respective vehicle batteries.

U.S. Pat. No. 4,829,223 teaches a vehicle battery charger including a connector. However the connector in this case non-hermaphroditic. U.S. Pat. No. 4,885,524, issued to Wilburn on Dec. 5, 1989, teaches a two- or three-part battery jumping system in which the battery is fitted with an elaborate structure that permits the interconnection of two similarly fitted vehicles to jump-start each other or to connect one system by using an adapter cable to another vehicle's battery. The connectors are only capable of one-way connection to ensure proper polarity.

U.S. Pat. No. 4,963,102, issued to Gettig et al. on Oct. 16, 1990, the disclosure of which is hereby incorporated by reference, teaches a hermaphroditic electrical connector. U.S. Pat. No. 5,707,250, issued to Smithson on Jan. 13, 1998, teaches a quick disconnect cable for a battery to ensure easy removable of the battery for maintenance, replacement, or emergency. U.S. Pat. No. 6,123,576, issued to James on Sep. 26, 2000, teaches a two-part jumper cable using a one-way connector and clamps at the ends for attaching to respective batteries. U.S. Pat. No. 6,343,949, issued to Floyd on Feb. 5, 2002, teaches a modular jumper cable in which the battery-connecting ends are permanently attached to the respective battery terminals using eyelets. The connectors that connect the cable parts can be oriented in only one way to maintain proper polarity None of the above inventions and patents, taken either singly or in combination, is seen to describe the instant invention as claimed. Thus, motorcycle jumper cables solving the aforementioned problems are desired.

### SUMMARY OF THE INVENTION

The invention is directed to motorcycle jumper cables, and to a battery charger having a connector which is attachable to the jumper cables. In particular, the inventive cable includes a hermaphroditic connector that ensures proper polarity when the cable is connected either to another motorcycle or other vehicle battery, or to the battery charger.

Moreover, the inventive cable can be provided in a kit form to include a first cable section connected permanently at one end to the terminals of a motorcycle battery and having a hermaphroditic connector at its opposite end, a second cable section equipped with a hermaphroditic connector at one end and clamps at its opposite end for connecting to the terminal posts of a standard post-type battery, and a third cable section equipped with hermaphroditic connectors at both ends for connecting the first and second cable sections, e.g., as for boosting a motorcycle battery from a car battery or for boosting one motorcycle from another motorcycle equipped with the same cable section.

Accordingly, it is a principal object of the invention to provide a motorcycle jumper cable having a hermaphroditic connection to ensure proper polarity during transfer of power between two batteries.

It is another object of the invention to provide a motorcycle jumper cable having a first section fixed to a motorcycle's battery, a second section attachable to a charging battery, and an additional intermediate section to connect the first two sections together.

It is a further object of the invention to provide a motorcycle jumper cable kit with a first jumper cable section fixed to a motorcycle's battery, at least one additional jumper cable section for connecting the first cable section to a charging battery, and a battery charger having a cable connector compatible with either the first or second section of the jumper cable for either charging the motorcycle battery, or for providing a boost for starting the motorcycle.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view showing a motorcycle jumper cable according to the present invention including three cable portions.

FIG. 2 is a perspective view of the inventive cable in the form of a 3-part kit.

FIG. 3 is a perspective view of the battery charger including the hermaphroditic connection.

Similar reference characters denote corresponding features consistently throughout the attached drawings.

### DETAILED DESCRIPTION OF THE PREFERRED EMBODIMENTS

The present invention is directed to a multi-part jumper cable for boosting the battery of a motorcycle or for charging a motorcycle battery using hermaphroditic connectors.

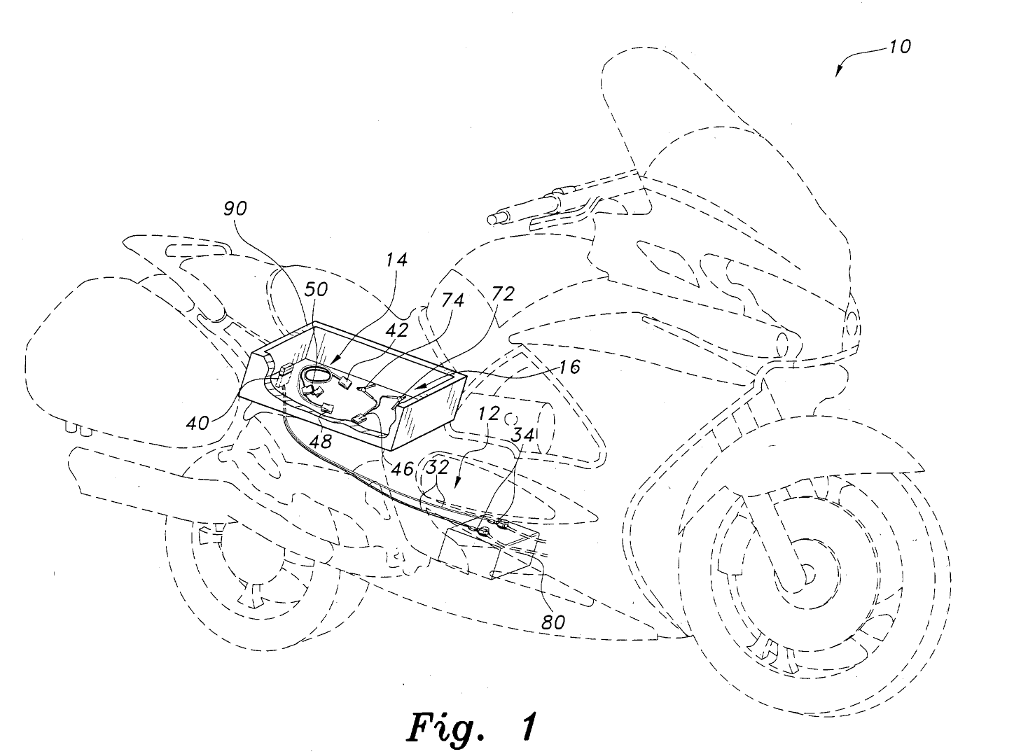

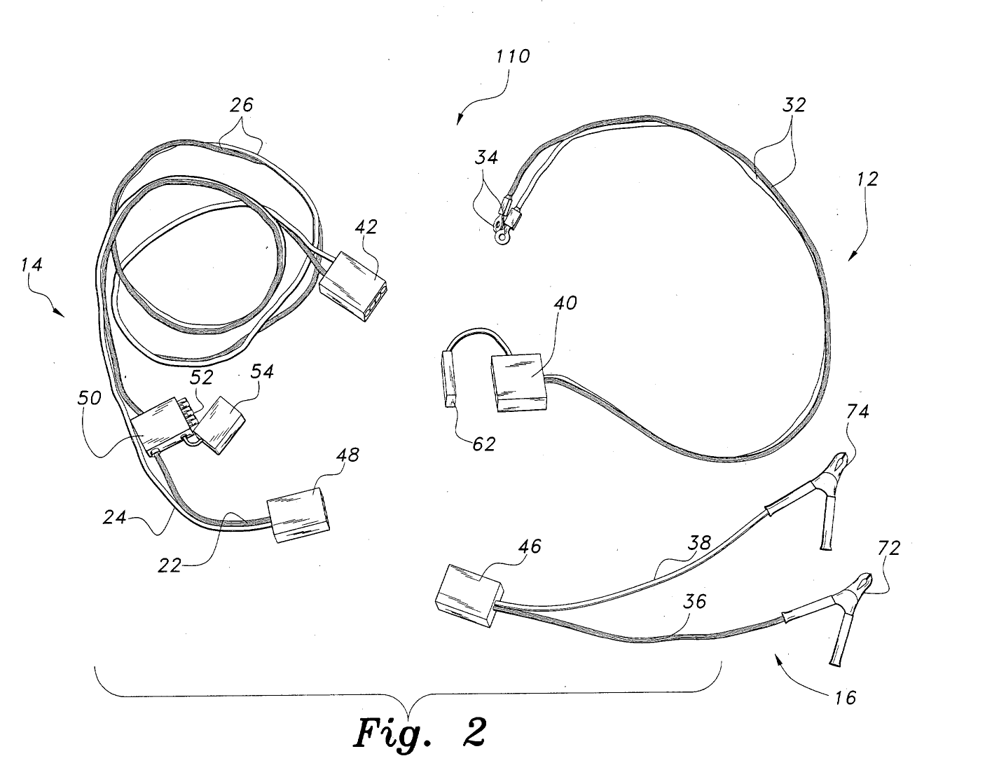

FIG. 1 shows a cutaway view of a motorcycle 10 showing a motorcycle battery 80, a first portion 12 of the multi-part jumper cable connected at one end to the battery terminals 34, and a housing 90 containing a second portion 14 and a third portion 16 of the jumper cable. FIG. 2 shows a detailed view of a kit including all three sections that make up the multi-part jumper cable, i.e., sections 12, 14, and 16.

The permanently installed cable section 12 includes two electrical cables 32 color-coded to distinguish between the positive cable (preferably colored red) and the negative cable (preferably colored black), so that a person using the cable will maintain proper polarity during use, i.e., when “jumping” or “boosting” the battery when it is undercharged. In the figures, the darker colored cable corresponds with the positive cable and, conversely, the lighter colored cable corresponds with the negative cable.

The housing 90 defines a storage compartment for the second and third portions, 14 and 16. Depending upon the type of motorcycle, the storage compartment may be located under the seat as shown. Alternatively, the storage compartment may be elsewhere, such as to the rear or either side of the seat.

The second portion 14 of the multi-part jumper cable has first and second ends including hermaphroditic connectors, 42 and 48, respectively, and a fuse 50 intermediate the two ends on the positive cable 22, preferably having a rating of 30 amps.

The third portion 16 of the jumper cable is provided at one end with a hermaphroditic connection 46. The opposite end of the third portion 16 of the jumper cable has positive and negative cables, 36 and 38, respectively, and terminates in alligator type clamps 72 and 74 which are adapted for attachment to the terminal posts of a post-type charging battery, such as the type commonly used on passenger vehicles.

When the battery 80 is undercharged and requires a “jump” or a “boost” from another battery, such as from a car battery, the motorcycle is placed in relative proximity to the car (or other vehicle). Jumper cable section 16 is removed from the storage compartment 90 and clamps 72 and 74 are attached to the respective positive and negative terminal posts of the post-type charging battery. Then cable section 14 is removed from the storage compartment and one end (i.e., either connector 42 or 48) is connected to connector 40 of the first section and the opposite end (i.e., remaining connector 48 or 42) is connected to connector 46 of the second section, thereby completing the boosting circuit.

Hermaphroditic connectors 40 and 42 may be any known type of hermaphroditic connector in which the connectors are identical, and which can only be connected in a manner in which the polarity is ensured, i.e., in which the positive terminal of the fully charged battery is directly connected with the positive terminal of the undercharged battery and the shape of the positive terminal on each connector is identical. Preferably the hermaphroditic connector is of a type exemplified by the connector taught in U.S. Pat. No. 4,963,102, previously incorporated herein. It is noted that although the reference teaches a three-conductor cable, the same connector is used herein for connecting a two-connector cable, i.e., a cable having a positive and a negative cable corresponding to the positive and negative poles of a vehicle battery.

On the positive cable wire 22 a fuse 52 is provided. The fuse is contained in its own housing 50 with a protective cap 54. The fuse is preferably a thirty ampere (30A) blade fuse that corresponds with the wire gauge size capable of “jumping” batteries, e.g., ten gauge AWG.

Thus, the additional extension section 14 may be used either to connect a first jumper cable section 12 fixed to the battery of the motorcycle receiving the jump start to a another first jumper cable section 12 attached to the charging battery on a second motorcycle, or as an extension cable between the first jumper cable section 12 and second jumper cable section 16 to extend the length of the jumper cable when charging from a passenger car or other vehicle. Preferably, cable portions 12 and 16 are approximately 3 feet in length, and cable portion 14 is approximately 6 feet in length.

When two motorcycles are equipped with a 3-piece kit as shown in FIG. 2, one of the motorcycles can then be used to “jump-start” the second by simply connecting the installed cable section 12 of the two motorcycles together with an extension 14.

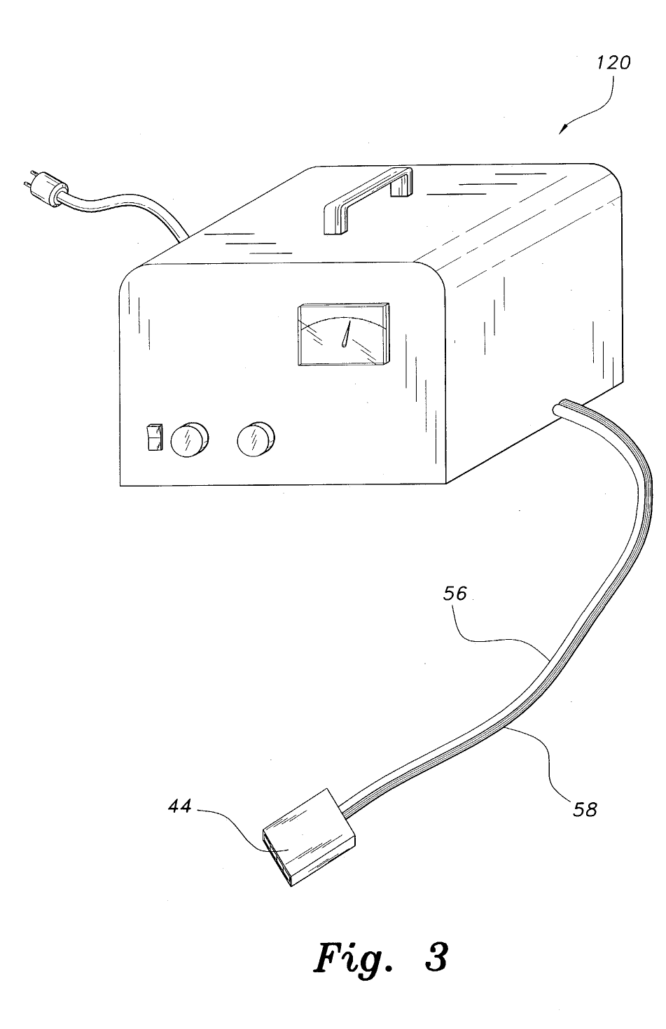

FIG. 3 shows an optional battery charger 120 including a hermaphroditic connector 44 that ensures proper polarity in the wires 56 and 58 during use. The battery charger 120 shown in FIG. 3 is switchable between a trickle charge mode for deep charging of the battery, and a starting mode for providing a current boost to the dead battery during starting of the vehicle. The hermaphroditic connector 44 may be attached directly to connector 40 of the first jumper cable section 12, or indirectly through connector 42 or 48 of extension cable 14. Battery charger 120 may be included with the kit 110 (FIG. 2). Alternatively, a rechargeable battery booster equipped with cables, 56 and 58, and hermaphroditic connector 44 may be substituted for battery charger 120.

Although a three-part jumper cable has been discussed and is preferred, a two-part kit including the first section 12 and second section 16 is also contemplated as an optional alternative.

It is to be understood that the present invention is not limited to the embodiments described above, but encompasses any and all embodiments within the scope of the following claims.

I claim:

1. A motorcycle jumper cable, comprising:
a first jumper cable section made from two-wire cable and having a first end adapted for being fixed to a motorcycle battery installed on a motorcycle, and having a second end, the two-wire cable having color-coded insulation on the two wires;
a first hermaphroditic cable connector attached to the second end of the first jumper cable section;
a second jumper cable section made from two-wire cable, the two-wire cable having the same color-coded insulation as the first jumper cable section, the second jumper cable section having a first end and a second end;
alligator clamps attached to the first end of the second jumper cable section, the alligator clamps being dimensioned and configured for attachment to battery posts of a charging battery; and
a second hermaphroditic cable connector attached to the second end of the second jumper cable section;
wherein the first and second hermaphroditic cable connectors have an identical configuration and releasably mate with each other in order to electrically connect the first jumper cable section with the second jumper cable section while maintaining proper polarity between the two-wire cables.

2. The motorcycle jumper cable according to claim 1, further comprising a third jumper cable section made from two-wire cable having the same color-coded insulation as said first and second jumper cable sections, the third jumper cable section having a first end and a second end and having a hermaphroditic cable connector attached to the first and second ends;
whereby the third jumper cable section is inserted between said first and second jumper cable sections to extend the length of the motorcycle jumper cable; and
wherein the third jumper cable section is adapted for insertion between said first jumper cable section attached to a first motorcycle and another said first jumper cable section attached to a second motorcycle for establishing a jump start connection.

3. The motorcycle jumper cable according to claim 1, further comprising eyelets electrically connected to the first end of said first jumper cable section for fixing the first end of said first jumper cable section to the motorcycle battery.

4. The motorcycle jumper cable according to claim 1, wherein the two-wire cable of said first and second jumper cable sections are each color coded red and black, respectively.

5. The motorcycle jumper cable according to claim 1, further comprising a fuse inserted in one wire of the two-wire cable of said second section.

6. The motorcycle jumper cable according to claim 1, wherein the two-wire cable of said first and second jumper cable sections comprises ten gauge AWG wire.

7. A motorcycle jumper cable in combination with a motorcycle, comprising:
a motorcycle having a motorcycle battery installed thereon;
a first jumper cable section made from two-wire cable and having a first end fixed to the motorcycle battery, and having a second end, the two-wire cable having color-coded insulation on the two wires
a first hermaphroditic cable connector attached to the second end of the first jumper cable section;
a second jumper cable section made from two-wire cable, the two-wire cable having the same color-coded insulation as the first jumper cable section, the second jumper cable section having a first end and a second end;
alligator clamps attached to the first end of the second jumper cable section, the alligator clamps being dimensioned and configured for attachment to battery posts of a charging battery; and
a second hermaphroditic cable connector attached to the second end of the second jumper cable section;
wherein the first and second hermaphroditic cable connectors have an identical configuration and releasably mate with each other in order to electrically connect the first jumper cable section with the second jumper cable section while maintaining proper polarity between the two-wire cables.

8. The motorcycle jumper cable in combination with a motorcycle according to claim 7, further comprising a third jumper cable section made from two-wire cable having the same color-coded insulation as said first and second jumper cable sections, the third jumper cable section having a first end and a second end and having a hermaphroditic cable connector attached to the first and second ends;
whereby the third jumper cable section is inserted between said first and second jumper cable sections to extend the length of the motorcycle jumper cable; and
wherein the third jumper cable section is adapted for insertion between said first jumper cable section attached to a first motorcycle and another said first jumper cable section attached to a second motorcycle for establishing a jump start connection.

9. The motorcycle jumper cable in combination with a motorcycle according to claim 7, further comprising eyelets electrically connected to the first end of said first jumper cable section for fixing the first end of said first jumper cable section to the motorcycle battery.

10. The motorcycle jumper cable in combination with a motorcycle according to claim 7, wherein the two-wire cable of said first and second jumper cable sections are each color coded red and black, respectively.

11. A motorcycle jumper cable kit, comprising:
a first jumper cable section made from two-wire cable and having a first end adapted for being fixed to a motorcycle battery installed on a motorcycle, and having a second end, the two-wire cable having color-coded insulation on the two wires;
a first hermaphroditic cable connector attached to the second end of the first jumper cable section;
a second jumper cable section made from two-wire cable, the two-wire cable having the same color-coded insulation as the first jumper cable section, the second jumper cable section having a first end and a second end;
alligator clamps attached to the first end of the second jumper cable section, the alligator clamps being dimensioned and configured for attachment to battery posts of a charging battery;
a second hermaphroditic cable connector attached to the second end of the second jumper cable section; and
a battery charger having a two-wire cable terminating in a third hermaphroditic cable connector;
wherein the first, second and third hermaphroditic cable connectors have an identical configuration and releasably mate with each other in order to either electrically connect the first jumper cable section with the second jumper cable section while maintaining proper polarity between the two-wire cables, or to electrically connect the first jumper cable section with the battery charger.

12. The motorcycle jumper cable kit according to claim 9, further comprising a third jumper cable section made from two-wire cable having the same color-coded insulation as said first and second jumper cable sections, the third jumper cable section having a first end and a second end and having a hermaphroditic cable connector attached to the first and second ends;
whereby the third jumper cable section is inserted between said first and second jumper cable sections to extend the length of the motorcycle jumper cable; and
wherein the third jumper cable section is adapted for insertion between said first jumper cable section attached to a first motorcycle and another said first jumper cable section attached to a second motorcycle for establishing a jump start connection.
